(19) United States
(12) Patent Application Publication
(10) Pub. No.: US 2020/0111082 A1
(43) Pub. Date: Apr. 9, 2020

(54) DIGITAL PROPERTY REMITTANCE VIA TELEPHONE NUMBERS THROUGH TELECOM CARRIERS

(71) Applicant: TBCASOFT, INC., Sunnyvale, CA (US)

(72) Inventor: Ling WU, San Jose, CA (US)

(73) Assignee: TBCASOFT, INC., Sunnyvale, CA (US)

(21) Appl. No.: 16/499,873

(22) PCT Filed: Apr. 5, 2018
(86) PCT No.: PCT/US2018/026344

§ 371 Date: Oct. 1, 2019

Related U.S. Application Data
(60) Provisional application No. 62/481,693, filed on Apr. 5, 2017.
(60) Provisional application No. 62/506,947, filed on May 16, 2017.

(51) Int. Cl. G06Q 20/36; G06Q 20/32; G06Q 20/06; G06Q 20/40; G06K 9/00

(52) U.S. Cl. CPC G06Q 20/3674; G06Q 20/3229; G06K 9/00892; G06Q 20/40145; G06Q 20/0655

(57) ABSTRACT

The present disclosure is directed to one or more methods, systems, apparatuses, and computer readable mediums storing processor-executable process steps for processing a digital property remittance request from a sender's virtual wallet created based on a sender's telephone number subscribed from a sender's telecom carrier to a recipient's virtual wallet created based on a recipient's telephone number subscribed from a recipient's telecom carrier. The method comprises (a) receiving, via a telephone device, the digital property remittance request; (b) verifying, by the sender's telecom carrier, that the telephone device is an authenticated telephone device corresponding to the sender's telephone number; and (c) submitting, by the telephone device, after verification, the digital property remittance request to a distributed transaction consensus network for recording on a distributed ledger.

### RELATED APPLICATION

This application claims priority to U.S. provisional patent application No. 62/481,693, filed on Apr. 5, 2017 and U.S. provisional patent application No. 62/506,947, filed on May 16, 2017, the entire disclosure of which is herein incorporated by reference.

### BACKGROUND OF THE INVENTION

### Description of Related Art

Mobile phone numbers alone can be used as an identification (“ID”) for virtual wallets of entities, either individuals or business (a partnership, corporation, or other type of legal entity). This approach can be implemented in an App (software installed in mobile devices). Thus, crypto currency, such as bitcoin and ethereum, can be transferred between virtual wallets identified by two different mobile phone numbers. A sender can pay crypto currency from a first virtual wallet identified by the sender's mobile phone number to a second virtual wallet identified by the recipient's own mobile phone number. However, the fact that the ownership of a mobile phone number can be changed but the App handling crypto currency transfer has no knowledge of such change may happen. In this case, the crypto currency can be transferred from or to a wrong virtual wallet. Moreover, since the mobile phone number is only served as an ID corresponding to a virtual wallet, which does not really connect to telecom carriers, more fraud may occur. Sending a passcode, e.g. via a message, to the mobile phone number cannot completely solve the problem because a third party may be able to intercept the passcode.

### SUMMARY

The present disclosure is directed to one or more methods, systems, apparatuses, and computer readable mediums storing processor-executable process steps for processing a digital property remittance request from a sender's virtual wallet created based on a sender's telephone number subscribed from a sender's telecom carrier to a recipient's virtual wallet created based on a recipient's telephone number subscribed from a recipient's telecom carrier. The method comprises (a) receiving, via a telephone device, the digital property remittance request; (b) verifying, by the sender's telecom, that the telephone device is an authenticated telephone device corresponding to the sender's telephone number; and (c) submitting, by the telephone device, after verification, the digital property remittance request to a distributed transaction consensus network for recording on a distributed ledger.

Additional features and advantages of the disclosure will be set forth in the descriptions that follow, and in part will be apparent from the descriptions, or may be learned by practice of the disclosure. The objectives and other advantages of the disclosure will be realized and attained by the structure and method particularly pointed out in the written description and claims thereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a schematic diagram illustrating the relationship between a telephone number, corresponding virtual wallets, and authenticated telephone device.

FIG. 2 is a schematic diagram illustrating the relationship between a telephone number, corresponding telecom carrier's account, corresponding virtual wallets, and authenticated telephone device.

FIG. 3 is a schematic diagram showing telephone devices, telecom carriers, and virtual wallets, as well as the telecom network and transaction network connecting them.

FIG. 4 is a diagram illustrating a phone App window for a sender to initiate a digital property remittance request.

FIG. 5 is a diagram illustrating an alternative phone App window for a sender to initiate a digital property remittance request.

FIG. 6 is a diagram illustrating a phone App window for a sender to enter the remittance amount.

FIG. 7 is a schematic diagram illustrating a distributed transaction consensus network.

FIG. 8 is a block diagram illustrating an example node of the above network.

FIG. 9 is block diagram showing digital property issuers (which are the telecom carriers in this application), telephone number subscribers, and virtual wallets.

### DETAILED DESCRIPTION OF PREFERRED EMBODIMENTS

The terminology used in the description presented below is intended to be interpreted in its broadest reasonable manner, even though it is used in conjunction with a detailed description of certain specific embodiments of the technology. Certain terms may even be emphasized below; however, any terminology intended to be interpreted in any restricted manner will be specifically defined as such in this Detailed Description section.

The embodiments introduced below can be implemented by programmable circuitry programmed or configured by software and/or firmware, or entirely by special-purpose circuitry, or in a combination of such forms. Such special-purpose circuitry (if any) can be in the form of, for example, one or more application-specific integrated circuits (ASICs), programmable logic devices (PLDs), field-programmable gate arrays (FPGAs), etc.

The described embodiments concern one or more methods, systems, apparatuses, and computer readable mediums storing processor-executable process steps for submitting a digital property remittance request from a telephone device via telecom carriers to a distributed transaction consensus network. The digital property remittance request is to transfer digital property from a sender's virtual wallet created based on a sender's telephone number subscribed from a sender's telecom carrier to a recipient's virtual wallet created based on a recipient's telephone number subscribed from a recipient's telecom carrier. The digital property remittance request is received by a telephone device first. The sender's telecom carrier then has to verify that such telephone device is an authenticated telephone device corresponding to the sender's telephone number. After the verification, the telephone device submits the digital property transaction request, via the carriers, to a distributed transaction consensus network for recording the remittance on a distributed ledger. Herein the term “remittance” is defined to mean transferring of digital property from a sender's virtual wallet to a recipient's virtual wallet. Thus, digital property remittance includes transferring digital property between any two different virtual wallets regardless of whether the owner of the virtual wallet is an individual (who purchases products or services) or a merchant (which provides products or services). In addition, digital property remittance includes transferring digital property only from a telecom carrier's virtual wallet to its subscriber's virtual wallet (also referred to as “deposit”) and only from a subscriber's virtual wallet to his/her telecom carrier's virtual wallet (also referred to as “withdrawn”). In other words, digital property remittance can be (1) depositing or withdrawing digital property to or from a subscriber's virtual wallet created based on the subscriber's telephone number subscribed from his/her telecom carrier or (2) transferring digital property from the sender's virtual wallet created based on a sender's telephone number subscribed from a sender's telecom carrier to a recipient's virtual wallet created based on a recipient's telephone number subscribed from a recipient's telecom carrier.

In one embodiment, a sender subscribes a sender's telephone number from a sender's telecom carrier first. The sender's telecom carrier then created a sender's virtual wallet based on the sender's telephone number. As a result, the sender's telephone number is a key identifier of the sender's virtual wallet. Similarly, a recipient subscribes a recipient's telephone number from a recipient's telecom carrier first. The sender's telecom carrier then creates a recipient's virtual wallet based on the recipient's telephone number. The recipient's telephone number is a key identifier of the recipient's virtual wallet. For example, a sender, William, subscribes a sender's telephone number, 123-456-7890 from a sender's telecom carrier, ATT Mobile (“ATT”), and thus creates a sender's telephone number account. When a call is made from the sender's telephone number, a predetermined fee will be charged to the sender's telephone number account. ATT can then create a virtual wallet based on the William's telephone number. In one embodiment, since this virtual wallet is created based on William's telephone number subscribed from ATT, if William terminates his telephone number subscription, this virtual wallet will have to be closed as well. In another embodiment, if William changes his phone number within ATT, the original virtual wallet may be carried over and be identified by William's new number. However, at any given time, a virtual wallet can be identified by one sender's telephone number. In this situation, the sender's new telephone number is the only sender's telephone number to identify the sender's virtual wallet. The sender's virtual wallet is considered as created based on the sender's new number in this application. The same applies in the situation that the recipient changes to a new number subscribed from the same sender's telecom carrier.

Each virtual wallet has a virtual wallet ID, which in some embodiment can be the virtual wallet address. In addition, each virtual wallet has a public key and a private key. To spend the digital property stored in his or her virtual wallet, the owner has to use the private key associated with the virtual wallet to sign the remittance. A telephone number subscriber can open/create and own a plurality of virtual wallets based on the same subscriber's telephone number. A virtual wallet is provided to store, send, receive, and manage digital properties, including multiple types of digital assets, credits, and obligations, such as digital currencies, digital securities, digital bonds, digital futures, digital precious metals and digital fee tokens, for a telephone number subscriber, e.g. an individual, a merchant, and a telecom carrier. In one embodiment, a virtual wallet may be an electronically maintained data file which may comprise authentication information, rules for use. Each virtual wallet is associated with a telecom carrier and can be identified by a virtual wallet ID (or address in some embodiment), e.g. 1F1tAaz5x1HUXrCNLbtMDqcw6o5GNn4xq and 16ULZUJwv1HZJkFrs8aa9c3xHTjiayyTNS. In one embodiment, a virtual wallet corresponding to a telephone number or its account can only store, send, receive, and manage various digital properties issued by the telecom carrier (digital property issuer) from which the telephone number is subscribed.

In one embodiment, the sender's telecom carrier is the same as the recipient's telecom carrier while the sender's telephone number is different from the recipient's telephone number. In one embodiment, the sender can only remit, including deposit, transfer, or withdraw, digital property to or from his/her virtual wallet by using the only one authenticated telephone device at that time corresponding to the sender's telephone number subscribed from the sender's telecom carrier. In one embodiment, when the sender's telecom carrier detects more than one authenticated telephone devices corresponding to one single telephone number, it can withhold the digital property remittance request and conduct further investigation, for example, asking more information regarding the telephone device and/or the sender.

In one embodiment, the digital property to be transferred from the sender's virtual wallet to the recipient's virtual wallet cannot be temporarily converted to another type of digital currency acting as a middle medium only for transfer purpose, such as bitcoin and ethereum, whose exchange rate to the original digital property may change along the time, in order to avoid the value fluctuation of the original digital property. For example, the exchange rate for bitcoin to digital US dollars (original digital property) changes from time to time. Thus, the UD Dollar digital property cannot be changed to bitcoin only as a middle medium for transfer purpose and then changed back to US Dollar digital property or Japanese Yen digital property after arriving the recipient's virtual wallet. In one embodiment, the digital property to be remitted is a type of digital currency whose real-world value does not change because of the remittance. In one embodiment, virtual wallets cannot store digital currency whose value is not subject to the governance of a nation's central bank or equivalent organization, such as bitcoin and ethereum. In one embodiment, the transactions between the sender's virtual wallet and the recipient virtual wallet are recorded in a distributed ledger. In one embodiment, the distributed ledger uses blockchain data format. In one embodiment, the distributed ledger is created based on cryptographic technology in a distributed transaction consensus network.

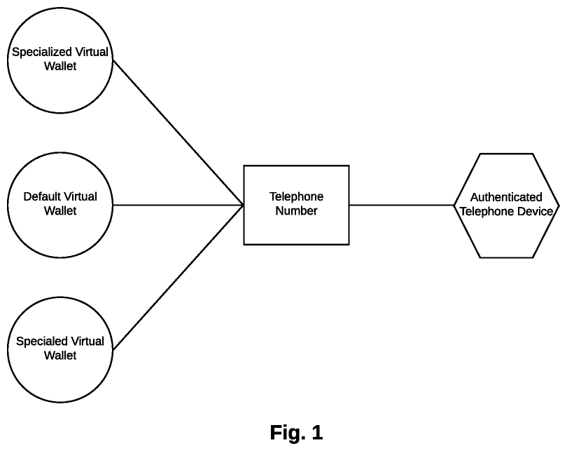

In one embodiment shown in FIG. 1, a telephone number can correspond to one or more virtual wallets which can store digital properties. That is to say, the subscriber of the telephone number can concurrently create a plurality of virtual wallets of which one is selected to be the default virtual wallet. A digital property can be any of digital currencies, digital securities, digital bonds, digital futures, digital precious metals or digital fee tokens. The telephone number and the authenticated telephone device are in one to one correspondence. In other words, each telephone number should have only one authenticated telephone device from which a digital property transaction request can be initiated.

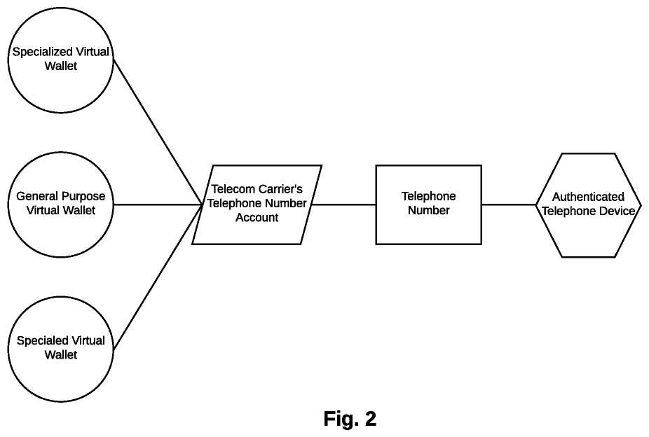

In another embodiment shown in FIG. 2, a plurality of virtual wallets correspond not only to the single telephone number, but also to the owner's single telephone number account with a telecom carrier. Thus, when the subscriber of such telephone number terminates his or her agreement with the telecom carrier, the corresponding virtual wallets are closed at about the same time or carried over to the subscriber's new number (and the corresponding new telephone number account) subscribed from the same telecom carrier. Such terminated telephone number is released and may be assigned to another person in the future. When the subscriber carries such telephone number to a new telecom carrier, a new virtual wallet associated with the new telecom carrier should be created. The subscriber can choose to transfer the digital property stored at the old virtual wallet associated with the former telecom carrier to the new virtual wallet associated with the new telecom carrier. One telephone number (or its account with a telecom carrier) may correspond to a plurality of virtual wallets among which one virtual wallet is selected to be the default virtual wallet for digital property remittance. However, one virtual wallet can correspond to only one telephone number account of a telecom carrier, which corresponds to only one telephone number, which corresponds to only one authenticated telephone device.

A telephone number corresponds to an authenticated telephone device at a single time used to initiate the digital property remittance function, including deposit, transfer, and withdrawal. A telecom carrier can verify whether the telephone device initiating the digital property remittance request is the only authenticated telephone device at that time via a telephone device authentication mechanism, such as a SIM card, eSIM, or other authentication approaches. Thus, a sender can use his/her authenticated telephone device to deposit or withdraw digital property to or from the sender's virtual wallet (corresponding to the sender's telephone number account of the sender's telecom carrier). A sender can also use his/her authenticated telephone device to transfer digital property to a recipient's virtual wallet (corresponding to the recipient's telephone number account of the recipient's telecom carrier). The telephone number can be either a mobile telephone number or a landline telephone number. In a dual-SIM phone, a selected (or default) telephone number is used as the sender's telephone number to initiate the digital property deposit, transfer, or withdrawal function to or from a virtual wallet corresponding to the sender's telephone number account of the telecom carrier.

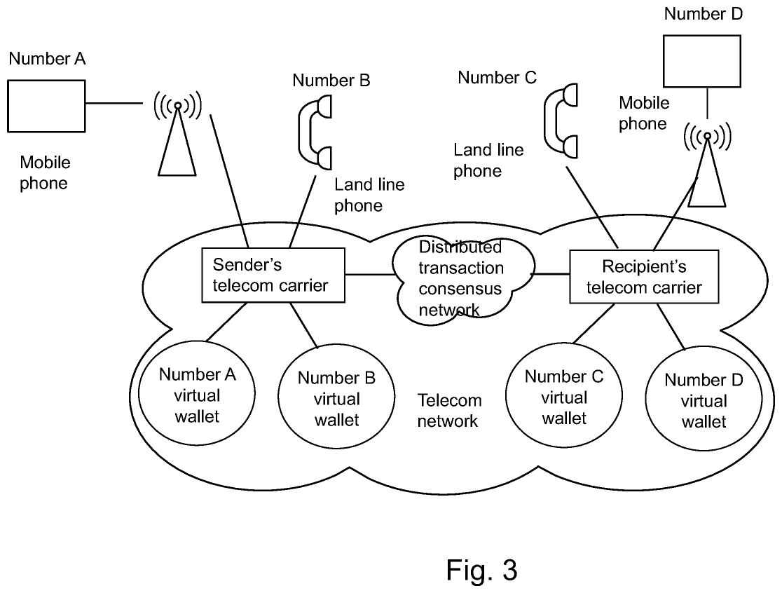

A sender can use his/her authenticated telephone device, either a mobile phone or a landline phone, corresponding to sender's telephone number to transfer digital property from a sender's virtual wallet associated with the sender's telecom carrier with which the sender subscribes his/her telephone number (“sender's telephone number”) to a recipient's virtual wallet associated with the recipient's telecom carrier with which the recipient subscribes his/her telephone number (“recipient's telephone number”). As shown in FIG. 3, a sender can use number A mobile phone, having a corresponding number A virtual wallet associated with a sender's telecom carrier with which the sender subscribes his/her telephone number A, to transfer digital property to a recipient's number C virtual wallet associated with a recipient's telecom carrier with which the recipient subscribes his/her telephone number C, via telecom network and transaction network.

A telephone device, such as the number A mobile phone and number B landline phone, can initiate, via a software, such as an App, installed in the telephone device, a digital property remittance request from a sender's virtual wallet created based on the sender's telephone number subscribed from the sender's telecom carrier to a recipient's virtual wallet created base on the recipient's telephone number subscribed from the recipient's telecom carrier. The telephone device includes a digital property remittance generator, a virtual wallet verifier, and a digital property remittance transmitter, each of which can be a software component executed by processors, memories, and input/output interfaces/units of the telephone device, or an application-specific integrated circuit (“ASIC”) specially designed to perform the required function. People with ordinary skill in the art would know how to program these software components or design the ASICs according to the disclosure in this application.

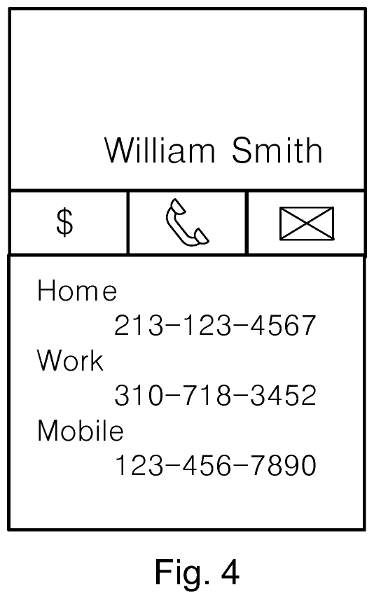

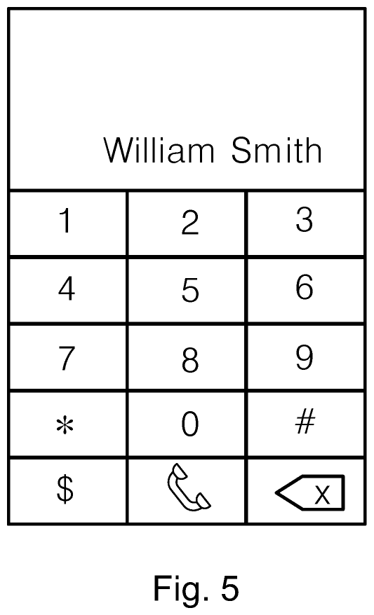

In one embodiment, the digital property remittance generator can be a software component, when executed, to receive a digital property remittance request which may include a sender's telephone number, a recipient's telephone number, and an amount of remittance or an instruction of calculating the amount of remittance. The digital property remittance generator can request the sender to enter the sender's telephone number or retrieve it from memory once it is stored. To enter a recipient's telephone number, the sender can search the recipient's name using a phone App or contacts App first. After the recipient's phone information is displayed on the screen, as shown in FIG. 4, the sender can press a remittance icon, e.g. a dollar sign $, to perform a remittance function, such as transfer or payment. In one embodiment, the remittance icon, the call icon, and the text icon can be displayed on the same screen. Thus, the sender can initiate a phone call or text message on the same screen as well. The sender can then select a recipient's telephone number (“recipient's telephone number”), e.g. from home number, work number, and mobile number, in a separate window. Alternatively, the sender can identify the recipient's telephone number either by selecting from a telephone number list or directly entering it from a number pad first, and then press the remittance icon to initiate a payment process. For example, in a phone App as shown in FIG. 5, a sender can enter a recipient's telephone number directly and press the remittance icon, such as a dollar sign $, on the same screen to initiate a remittance process, such as payment. The remittance icon can be displayed on the same screen as call icon (usually shown as a phone handset) and/or message icon (usually shown as a letter).

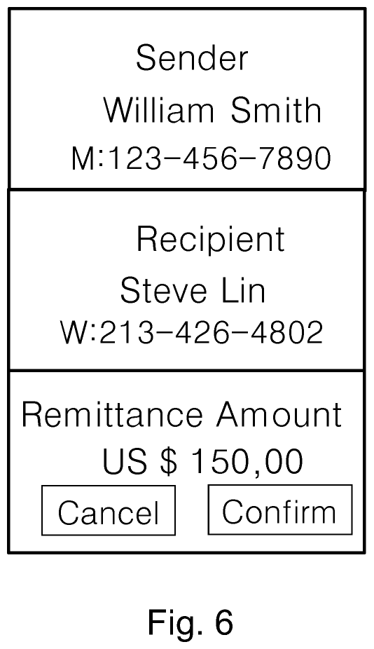

As shown in FIG. 6, the phone App will then ask the sender to enter the amount and type of digital property to be transferred to the recipient's virtual wallet corresponding to the recipient's telephone number or its account. For a phone App used in the US, the default type of digital currency to be transferred can be digital US Dollars. An icon or drop-down list is provided for the sender to select other type of digital property or currency for remittance, including transfer and payment. Another icon can be provided for the sender to check the current balance in the sender's virtual wallet corresponding to the sender's telephone number or its account.

In one embodiment, the virtual wallet verifier can be a software component, when executed, to verify whether the telephone device receiving the digital property remittance request (“initiating telephone device”) is the authenticated telephone device corresponds to the sender's telephone number based on which the sender's virtual wallet is created. If the sender changes to a new telephone number and has his/her original virtual wallet to be identified by the new telephone number, the virtual wallet is considered as created on the new telephone number. When the sender creates the sender's virtual wallet based on the sender's telephone number subscribed from the sender's telecom carrier, to ensure the remittance of any digital property stored in the sender's virtual wallet can only be initiated from the authenticated telephone device of the sender's telephone number so that the chance of unauthorized use can be minimized, the sender's virtual wallet is linked to the sender's telephone number used to create such virtual wallet. For example, the profile of the sender's virtual wallet will include sender's telephone number and its account with sender's telecom carrier. Upon receiving the digital property remittance request, in one embodiment, the virtual wallet verifier will first acquire from the subscriber identity module (“SIM”) card installed in the telephone device used to initiate the digital property remittance request, the international mobile subscriber identity (“IMSI”) and other related information for authentication of the telephone device. The IMSI is used to identify the user of a telecom/cellular network and is a unique identification associated with all telecom/cellular networks. Then, the telephone device will provide the IMSI and other related information such as Ki, to the virtual wallet verifier on a serer of the sender's telecom carrier.

In one embodiment when the sender's telecom carrier authenticates a telephone device via its SIM card. The authentication key (Ki) is used. The Ki is a 128-bit value used in authenticating the SIMs on a GSM mobile network (for USIM network, you still need Ki but other parameters are also needed). When a telephone device starts up, it obtains the IMSI from the SIM card, and passes this to the telecom carrier, requesting access and authentication. The telephone device may have to pass a PIN to the SIM card before the SIM card reveals this information. The carrier network searches its database for the incoming IMSI and its associated Ki. The carrier network then generates a random number (RAND, which is a nonce) and signs it with the Ki associated with the IMSI (and stored on the SIM card), computing another number, that is split into the Signed Response 1 (SRES_1, 32 bits) and the encryption key Kc (64 bits). The carrier network then sends the RAND to the telephone device, which passes it to the SIM card. The SIM card signs it with its Ki, producing SRES_2 and Kc, which it gives to the telephone device. The telephone device passes SRES_2 on to the carrier network. The carrier network then compares its computed SRES_1 with the computed SRES_2 that the telephone device returned. If the two numbers match, the SIM is authenticated and the telephone device is granted access to the carrier's network. Kc is used to encrypt all further communications between the telephone device and the carrier network.

The traditional removable SIM card technology is moved into e-SIM technology, which is also known embedded SIM, soft SIM, or remote SIM provisioning. The e-SIM technology is a new standard developed by GSMA allowing re-programmability and remote activation, giving users the ability to switch carriers without getting a new SIM card. Other authentication approaches can be used in these situations. The virtual wallet verifier works on the e-SIM situations in a similar manner.

In one embodiment, the virtual wallet verifier can be a software component stored in a server of the sender's telecom carrier, when executed, to verify whether the telephone device is the authenticated telephone device corresponding to the sender's telephone number. In other words, when the telephone device is such authenticated telephone device, the sender can make a phone call from the telephone device with the sender's telephone number. Again, the virtual wallet verifier in the server of the sender's telecom carrier will receive from the telephone device initiating the digital property remittance request the IMSI associated from its SIM card and can retrieve other related information from the SIM card for authentication. The virtual wallet verifier then verifies whether the telephone device is the authenticated telephone device corresponding to the sender's telephone number.

In one embodiment, the virtual wallet verifier can further verify whether the person pressing a bottom or icon to initiate the digital property remittance request (“initiating person”) is the authentic user of the sender' virtual wallet by evaluating the password, fingerprint, face recognition, iris recognition, voice authentication, and/or other attributes of the user. In one embodiment, the virtual wallet verifier can, according to the predetermined setting, request verification of 2 or more user attributes, such as both password and face recognition, if the remittance amount exceeds a preset amount. After such initiating person is authenticated/verified, the remittance process can proceed to the next step.

Thus, in one embodiment, the virtual wallet verifier can perform two varication functions: (1) verifying the telephone device initiating the remittance request is the authenticated telephone device corresponding to the sender's telephone number used to create the sender's virtual wallet; and (2) verifying the initiating person is the authentic user of the sender's virtual wallet. In one embodiment, both verification functions of the virtual wallet verifier can be jointly implemented in a single software component, such as the AuthenticateUser (UserInfo, IMSI), a carrier class function described in the pseudo code provided at the end of the detailed description.

In one embodiment, a digital property remittance transmitter on the telephone device can be implemented as a software component, when executed, to submit the digital property remittance request to a distributed transaction consensus system for recording on a distributed ledger, after the virtual wallet verifier verifies that the sender's virtual wallet corresponds to the sender's telephone number account whose authenticated telephone device is used to initiate the digital property remittance request.

The digital property remittance generator, the virtual wallet verifier, and the digital property remittance transmitter can be implemented in one or more Apps installed in the telephone device and the server of the sender's telecom carrier. A sender can initiate and manage the digital property remittance process, including deposit, transfer/payment, or withdrawal, through various people machine interfaces available in the telephone device, such as a hardware (physical) button, a touch screen, and voice recognition, etc. For example, a sender can initiate the remittance by pressing a hardware button (function key) on a telephone device without touch screen. A sender can also initiate the remittance by touching an icon/soft key on a display screen of the telephone device with touch screen. In one embodiment, the remittance icon can be a dollar sign or its variation. The remittance App can be a separate App from the phone App used to make/receive a phone call and text App used to send/receive a message. Nevertheless, the remittance function can be implemented in multiple Apps, including phone App, contacts App, bank App (such as BoA App), e-commerce store App (such as Amazon App).

For security reasons, a sender can only initiate a digital property remittance request from the authenticated telephone device corresponding to the sender's telephone number subscribed from the sender's telecom carrier. However, in some situation, a sender may be able to query his/her virtual wallet information from other devices such as a notebook or a tablet. In one embodiment, a recipient will be notified about the event of digital property to be transferred to his/her virtual wallet and has a right to decide whether to accept or decline the transfer. If an intended recipient declines the transfer of digital property, the digital property remittance request cannot be completed. A recipient can also set up the App in a manner that he/she will automatically accept a transfer of digital property.

A sender can use his or her authenticated telephone device, including a mobile phone and a landline phone, to transfer digital property from the sender's virtual wallet corresponding to the sender's telephone number or its account to the recipient's virtual wallet corresponding to the recipient's telephone number or its account. In addition, this remittance from a sender's virtual wallet to a recipient's virtual wallet can be integrated with services that can be provided or delivered to the sender's telephone device. In one embodiment, a sender can agree to pay a recipient the service fees calculated based on the length of a conversation, such as phone consultation services. When the telephone or video conversation/conference is ended, the service fees are transferred from the sender's virtual wallet corresponding to a sender's telephone number to a recipient's virtual wallet corresponding to a recipient's telephone number. For example, a client (a sender) can call an attorney or other consultant (a recipient) to discuss his or her case. Both parties agree on a certain hourly charge arrangement before the telephone/video conference, which can be achieved by e-signing an agreement via a mobile phone or a smart contract. When the conference call is completed, the remittance of the service fees can be instantly executed. Another example is that a sender can play online games via his/her smart phone and pays for the play time immediately. In general, any product or service that can be delivered via a telephone or an App installed in a telephone has a special advantage to be integrated with this call-to-pay function because both the payment and delivery of services or products can be accomplished at approximately the same time or within a short time period. Thus, with this technology, the trust or escort service between a sender (a buyer, a client) and a recipient (a seller, a service provider) becomes less important or even needless.

In one embodiment, a sender can have a plurality of virtual wallets, all of which correspond to the sender's telephone number or its account with the sender's telecom carrier but each of which can have a different usage. Similarly, a recipient can also have a plurality of virtual wallets for different usages. For example, William has seven (7) virtual wallets, the first one is a General Purpose Wallet (default wallet) that can be used for general remittance and payment, the second one is a Target Wallet that can be used only for purchases in Target stores, the third one is a Starbucks Wallet that can be used only for purchases in Starbucks, the fourth one is a Costco Wallet that can be used only for purchases in Costco, the fifth one is a PG&E Wallet that can be used only to pay PG&E utility bills, the sixth one is a Uber Wallet that can be used only to pay Uber, the seventh one is a Stanford Wallet that can be used only for purchases on Stanford Campus such as in restaurants, bookstores etc. on campus. The second to the seventh virtual wallets are specialized virtual wallets in which a digital property stored can only be remitted to one or more predetermined recipients' virtual wallets.

In one embodiment, a sender can buy a US $100 value Target gift card to a recipient by sending digital US $100 from the sender's General Purpose Wallet to the recipient's Target Wallet. Target Corporation (“Target”) can make arrangements with digital property issuers, such as telecom carriers, so that features of gift card transactions can be implemented by the Target Wallets. For example, each subscriber can have a Target Wallet if he or she wants. In addition, Target may receive some advanced payment or credit once a sender (buyer) deposits digital currency into his/her own or a third party's Target Wallet. As a result, Target can provide a discount, say 5%, to the sender (buyer). For example, a sender (buyer) only needs to pay US $95 in order to deposit digital US $100 into his/her Target Wallet provided that Target would receive the US $95 even before that money is spent at Target stores. Moreover, the digital currency stored in Target Wallet can be used in Target stores or be transferred to another person's Target Wallet. A rebate or donation to a designated school or organization can also be arranged when a person spends digital currency stored in a Target Wallet at Target stores. For example, when a sender spends US $100 from his/her Target Wallet for purchases at Target stores, US $5 (5% donation) will be given (donated) by Target to Waldorf School of Orange County. A distributed consensus transaction network can setup rules to implement the above features.

In another embodiment, a parent can send digital US $500 each month from his/her General Purpose Wallet to his/her child's Stanford Wallet, who is a Stanford student. As a result, the child can only spend the digital US $500 on Stanford campus, e.g. at cafeteria and book stores. Through this multiple virtual wallet approach, a distributed transaction consensus network can implement gift cards and/or restrict recipient's usage of digital property stored in a specialized virtual wallet.

As an alternative, digital property issuers, such as telecom carriers, can issue a merchant specific digital property which can be used for purchases in specific merchant stores. Those special digital property whose value can be realized only by such specific merchant. For example, ATT, as a digital property issuer, can issue 100 units of Target digital property $TGT.ATT ($TGT represents Target digital currency whose value is equivalent to digital UD Dollar; ATT represents the digital currency issued by ATT). William can purchase 100 $TGT.ATT for US $90 (at a 10% discount) and deposits in his own virtual wallet or a third party's virtual wallet. Via this approach, digital property issuers can choose to issue a new type of digital property for a specific merchant. Such merchant specific digital property can be stored in the same wallet, e.g. General Purpose Wallet, with other digital properties because it is distinguishable from other digital properties and its usage can be limited to a special purpose.

Again, Target can make arrangements with digital property issuers, such as telecom carriers, so that features of gift card transactions can be implemented by the merchant specialized digital property. For example, Target may receive some advanced payment or credit once a sender (buyer) deposits $TGT digital property into his/her own or a third party's virtual wallet. The Target digital property ($TGT) can be used for purchases in Target stores or be transferred to another person's virtual wallet. A rebate or donation to a designated school or organization can also be arranged when a person spends Target digital properties at Target stores. A distributed consensus transaction network can setup rules to implement the above features. This alternative approach can be applied to Starbucks, Amazon, and other merchants.

In one embodiment, a digital property remittance request from a sender's virtual wallet corresponding to the sender's telephone number or its account to a recipient's virtual wallet corresponding to the recipient's telephone number or its account, including deposit, transfer, and withdrawal, is accomplished by a distributed transaction consensus network and the remittance is recorded by a distributed ledger.

A distributed ledger is essentially a digital property database or data structure that can be shared across a distributed transaction consensus network of multiple nodes in various sites, geographies or institutions. All nodes within the network can have their own identical copy of the ledger. Any changes to the ledger are reflected in all copies in minutes, or in some cases, seconds. The security and accuracy of the digital properties stored in the ledger are maintained cryptographically through the use of keys and signatures to control who can do what within the distributed ledger. In an embodiment, a blockchain data structure is used for a distributed ledger.

In one embodiment, the management of digital properties, including to instantly clear and settle transactions of digital properties between two virtual wallets, based on cryptographic technology in a distributed transaction consensus network, applies the method and system described in the International Patent Application Number PCT/US17/12635 filed on Jan. 6, 2017, entitled “Digital Property Management On A Distributed Transaction Consensus Network.”

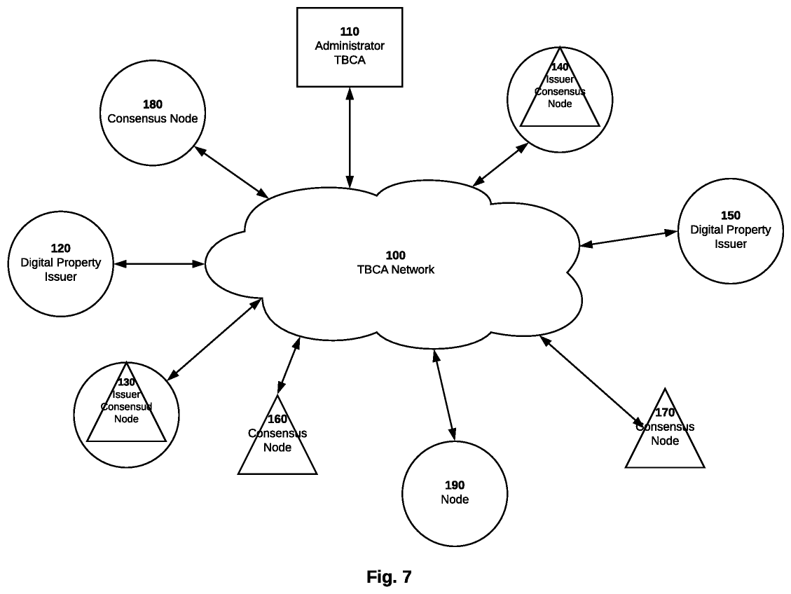

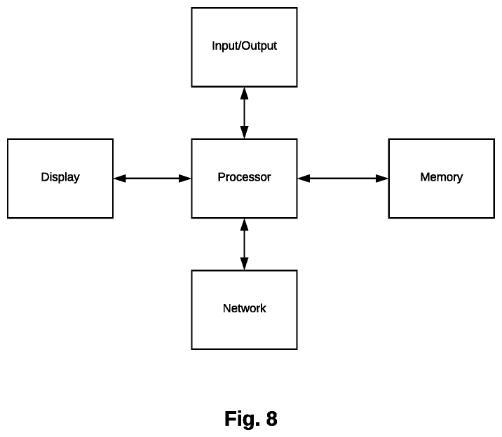

In one embodiment, as shown in FIG. 7, a distributed transaction consensus network 100, referred to as TBCA (The BlockChain Alliance) Network in this disclosure, using cryptographic technology, is implemented to manage digital properties in virtual wallets associated with telecom carriers with which senders and recipients register their telephone numbers. TBCA Network 100 comprises a plurality of nodes, including an administrator 110, digital property issuers 120, 130, 140, 150, and consensus nodes 160, 170, 180. As shown in FIG. 8, each node usually comprises a processor to perform calculations and execute programs; a memory to store software, programs, and data; a display to communicate with users; an input/output component to communicate with users and other devices, and a network component to connect with network via wiring or wireless channels.

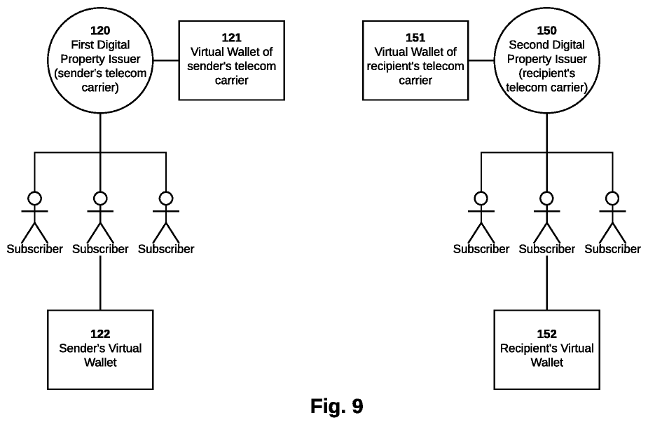

The administrator 110, referred to as TBCA in this disclosure, sets rules and manages the TBCA Network 100. The administrator 110 can issue digital fee tokens, referred to as T coin ($T) in this embodiment. The administrator 110 has a virtual treasury (not shown) to store digital fee tokens issued by itself or digital properties issued by other nodes. The administrator 110 can admit a node to join the distributed transaction consensus network 100 (TBCA Network) and become a member of the network. In addition, the administrator 110 (TBCA) can manage consensus nodes, including designate a single authenticated consensus node, determine a sequence of consensus nodes to be authenticated, and set the rules for the consensus nodes to check and support each other to prevent the consensus nodes from malfunction. Each digital property issuer 120-150 can issue various types of digital properties. In one embodiment, a digital property issuer is a telecom carrier. As shown in FIG. 9, the sender's virtual wallet 122 is associated with the sender's telecom carrier 120; the recipient's virtual wallet 152 is associated with the recipient's telecom carrier 150. A digital property remittance from the sender's virtual wallet to the recipient's virtual wallet can include 3 steps: (1) transferring the digital property from the sender's virtual wallet to the virtual wallet of the sender's telecom carrier, (2) transferring the digital property from the virtual wallet of the sender's telecom carrier to the virtual wallet of the recipient's telecom carrier, and (3) transferring the digital property from the virtual wallet of the recipient's telecom carrier to the recipient's virtual wallet. In one embodiment, a virtual wallet can only store the digital property issued by the telecom carrier with which the virtual wallet is associated.

A consensus node 160, 170, 180 can propose, validate, and record transactions in a distributed ledger (open to a member/node of TBCA Network 100). In some distributed transaction consensus network, a consensus node may receive a reward in exchange for the service it provides. In that situation, a consensus node is often referred to as a miner. The reward can be T coin issued by the administrator 110 (TBCA) and/or digital properties issued by digital property managers, which can be stored in a miner's virtual wallet (not shown). In other distributed transaction consensus network, a consensus node does not receive any reward. In that situation, a consensus node is often referred to as a validator. The validator who is authenticatedly proposing a new block is often referred to as a proposer or block proposer.

A distributed ledger can be a digital property database or data structure that can be shared across a distributed transaction consensus network of multiple nodes in various sites, geographies or institutions. In an embodiment, a blockchain data structure is used for a distributed ledger. Each block is identified by a block hash, made by hashing the block header twice through the SHA256 cryptographic algorithm. In addition, each block is referenced back to a previous block, known as the parent block, through a “previous block hash” field in the block header. Thus, the sequence of hashes links each block to its parent to create a chain going back all the way to the first block ever created. As the blocks pile on top of each other, it becomes exponentially harder to reverse the transactions. Therefore, transactions recorded in the blocks become more and more trusted over the time. Depending on the size of the block and transactions, an average block can contain several hundreds of transactions. A complete and up-to-date distributed ledger is stored in a database (or a file) of the administrator, digital property issuers, consensus nodes, and other nodes admitted by the administrator 110 to store such ledger (“full node”). Some nodes can select to store only a portion of such ledger. A consensus node can create a new block to record validated transactions, and then propagate the new block to other nodes of the network. However, a distributed ledger can use any other data structure known to people with ordinary skill in the art.

Below are sample pseudo codes for one embodiment disclosed in this section, which describes the following methods and processes:
The methods provided by a carrier
The methods provided by the TBCA Chain.
The process through which an application might register for a virtual wallet on behalf of a user through a carrier.
The process through which an application authenticates a user.
The process through which the user would deposit digital currency into his virtual wallet through an application.
The process through which the application would allow the user to transfer digital currency through a phone number to another user.
The process through which the user would withdraw digital currency from his virtual wallet through an application.

```
Carrier Methods
Class Carrier {
  // Authenticates a user with the carrier given information provided about the user, and a
SIM card IMSI
  UserToken AuthenticateUser(UserInfo, IMSI)
  // Retrieves a user with a corresponding UserToken
  User GetUserForToken(UserToken)
  // Retrieves a user with the corresponding UserInfo
  User GetUserWithInfo(UserInfo)
  // Charges the user, either in real time, or in the future, in physical currency
  Void Charge(User, Amount, Currency)
  // Credits the user, either in real time or in the future, in physical currency
  Void Credit(User, Amount, Currency)
  // Credits a merchant, either in real time or in the future, in physical currency
  Void Credit(Merchant, Amount, Currency)
  // Notifies a user
  Void Notify(User, Message)
  // Registers a user's virtual wallet
  Void RegisterUser(UserInfo) {
  User = Carrier.GetUserWithInfo(UserInfo)
  TBCACarrierChain.RegisterUser(User)
  }
  // Deposits digital currency into a user's virtual wallet
  Void Deposit(UserToken, Amount, Currency) {
  User = Carrier.GetUserForToken(UserToken)
  TBCACarrierChain.Deposit(User, Amount, Currency)
  }
  // Withdraws digital currency from a user's virtual wallet
  Void Withdraw(UserToken, Amount, Currency) {
          User = Carrier.GetUserForToken(UserToken)
      TBCACarrierChain.Withdraw(User, Amount, Currency)
  }
  // Remits digital currency to another user's virtual wallet identified by MSN
  Void Remit(UserToken, UserMsn, Amount, Currency) {
          User = Carrier.GetUserForToken(UserToken)
    TBCACarrierChain.Remit(User, UserMsn, Amount, Currency)
}
}
TBCA Chain Methods
Class TBCACarrierChain {
  // Registers a user to the TBCA carrier chain
  Void RegisterUser(User)
  // Makes a deposit for a user
  Job Deposit(User, Amount, Currency) {
            Carrier.Charge(User, Amount, Currency)
        Deposit = DoDepositLogic(User, Amount, Currency)
              Carrier.Notify(User, Deposit)
  }
  // Makes a withdrawal for a user
  Job Withdraw(User, Amount, Currency) {
            Carrier.Credit(User, Amount, Currency)
      Withdraw = DoWithdrawLogic(User, Amount, Currency)
Carrier.Notify(User, Withdraw)
  }
  // Sends a remittance to an MSN belonging to a user on the TBCA carrier chain
  Job Remit(User, UserMsn, Amount, Currency) {
ToUser = Carrier.GetUserForMsn(UserMsn)
      Remit = DoRemitLogic(User, ToUser, Amount, Currency)
              Carrier.Notify(User, Remit)
            Carrier.Notify(ToUser, Remit)
  }
}
User Application Methods
Registration
Class UserApplication {
  // Registers a user
  RegisterUser(UserInfo) {
  Carrier.RegisterUser(UserInfo)
}
}
Authentication
Class UserApplication {
  // This application's stored UserToken
  UserToken
  // Registers a user
Authenticate(UserInfo) {
  UserApplication.UserToken = Carrier.AuthenticateUser(UserInfo, SimCard.IMSI)
}
}
Deposit
Class UserApplication {
// This application's stored UserToken
  UserToken
  // Deposits into a user's virtual wallet
Deposit(UserToken, Amount, Currency) {
  Carrier.Deposit(UserToken, Amount, Currency)
}
}
Remit
Class UserApplication {
// This application's stored UserToken
  UserToken
  // Remits into another user's virtual wallet
Remit(UserToken, UserMsn, Amount, Currency) {
  Carrier.Remit(UserToken, UserMsn, Amount, Currency)
}
}
Withdraw
Class UserApplication {
// This application's stored UserToken
  UserToken
  // Withdraws from a user's virtual wallet
Withdraw(UserToken, Amount, Currency) {
  Carrier.Withdraw(UserToken, Amount, Currency)
}
}
}
*****************************************
```

It will be apparent to those skilled in the art that various modification and variations can be made in the digital property management method and related apparatus of the present invention without departing from the spirit or scope of the invention. Thus, it is intended that the present invention cover modifications and variations that come within the scope of the appended claims and their equivalents.

What is claimed is:

1. A method for processing a digital property remittance request from a sender's virtual wallet created based on a sender's telephone number subscribed from a sender's telecom carrier to a recipient's virtual wallet created based on a recipient's telephone number subscribed from a recipient's telecom carrier, the method comprising:
(a) receiving, via a telephone device, the digital property remittance request.
(b) verifying, by the sender's telecom carrier, that the telephone device is an authenticated telephone device corresponding to the sender's telephone number; and
(c) submitting, by the telephone device, after verification, the digital property remittance request to a distributed transaction consensus network for recording on a distributed ledger.

2. The method of claim 1, wherein the sender's telecom carrier is the same as the recipient's telecom carrier.

3. The method of claim 1, wherein the digital property remittance request comprises a sender's telephone number, a recipient's telephone number, and an amount of remittance or an instruction of calculating the amount of remittance.

4. The method of claim 1, further comprising:
displaying, by the telephone device, a remittance icon to be pressed to initiate the digital property remittance request.

5. The method of claim 4, wherein the remittance icon is displayed on a screen where a phone call icon is displayed.

6. The method of claim 4, wherein the remittance icon is a dollar sign.

7. The method of claim 1, wherein the sender's telecom carrier verifies that the telephone device is an authenticated telephone device corresponding to the sender's telephone number via a SIM card installed in the telephone device.

8. The method of claim 1, wherein the remitted digital property is a type of digital currency whose real-world value does not change because of the remittance.

9. The method of claim 8, wherein the remitted digital currency is not bitcoin or ethereum.

10. The method of claim 1, wherein step (a) further comprises receiving, via the telephone device, a user authentication information; and step (b) further comprises verifying, by at least the sender's telecom carrier or the telephone device, the digital property remittance request is initiated by an authentic user of the sender's virtual wallet.

11. The method of claim 10, wherein the verification of the authentic user is accomplished by evaluating one or more attributes selected from a group consisting of password, fingerprint, face recognition, iris recognition, and voice authentication.

12. The method of claim 1, further comprising delivering a service by a service provider to the telephone device.

13. The method of claim 12, wherein a value of the digital property remitted is determined by an agreement with the service provider.

14. The method of claim 12, wherein a value of the digital property remitted is determined by an amount of time the service is delivered to the telephone device.

15. The method of claim 1, wherein at least the sender's virtual wallet or the recipient's virtual wallet is a specialized virtual wallet in which a digital property stored can only be remitted to one or more predetermined recipients' virtual wallets.

16. The method of claim 1, wherein the digital property remitted is of a special type whose value can be realized only by a specific merchant.

17. A system for processing a digital property remittance request from a sender's virtual wallet created based on a sender's telephone number subscribed from a sender's telecom carrier to a recipient's virtual wallet created based on a recipient's telephone number subscribed from a recipient's telecom carrier, the system comprising:
a digital property remittance generator, in a telephone device, that receives the digital property remittance request;
a virtual wallet verifier, in a server of the sender's telecom carrier, that verifies the telephone device is an authenticated telephone device corresponding to the sender's telephone number; and
a digital property remittance transmitter that submits the digital property remittance request to a distributed transaction consensus network for recording on a distributed ledger.

18. The system of claim 17, wherein the sender's telecom carrier is the same as the recipient's telecom carrier.

19. The system of claim 17, wherein the digital property remittance request comprises a sender's telephone number, a recipient's telephone number, and an amount of remittance or an instruction of calculating the amount of remittance.

20. The system of claim 17, wherein the digital property transaction request is initiated by pressing a remittance icon displayed on the telephone device.

21. The system of claim 17, wherein the remittance icon is displayed on a screen of the telephone device where a phone call icon is displayed.

22. The system of claim 21, wherein the remittance icon is a dollar sign.

23. The system of claim 17, wherein the virtual wallet verifier verifies the telephone device is an authenticated telephone device corresponding to the sender's telephone number via a SIM card installed in the telephone device.

24. The system of claim 17, wherein the remitted digital property is a type of digital currency whose real-world value does not change because of the remittance.

25. The system of claim 17, wherein the remitted digital currency is not bitcoin or ethereum.

26. The system of claim 17, wherein the virtual wallet verifier also verifies that the digital property remittance request is initiated by an authentic user of the sender's virtual wallet.

27. The system of claim 26, wherein the verification of the authentic user is accomplished by evaluating one or more attributes selected from a group consisting of password, fingerprint, face recognition, iris recognition, and voice authentication.

28. The system of claim 17, further comprising a service receiver in the telephone device to receive a service delivered by a service provider to the telephone device.

29. The system of claim 28, wherein a value of the digital property remitted is determined by an agreement with the service provider.

30. The system of claim 28, wherein a value of the digital property remitted is determined by an amount of time the service is delivered to the telephone device.

31. The system of claim 17, wherein at least the sender's virtual wallet or the recipient's virtual wallet is a specialized virtual wallet in which a digital property stored can only be remitted to one or more predetermined recipients' virtual wallets.

32. The system of claim 17, wherein the digital property remitted is of a special type whose value can be realized only by a specific merchant.
